(19) United States
(12) Patent Application Publication
(10) Pub. No.: US 2009/0110411 A1
(43) Pub. Date: Apr. 30, 2009

(54) PRINTING SYSTEM AND METHOD FOR PURGING PRINT MEDIA

(75) Inventors: Mehmet Anil Gungor, Webster, NY (US); Donald R. Ryan, Webster, NY (US); Carol-Lynn Goldstein, Rochester, NY (US); Jeffrey Gramowski, North Chili, NY (US); Biruk Gossaye, Rochester, NY (US)

Correspondence Address: Xerox Corporation (CDFS), 445 Broad Hollow Rd.-Suite 420, Melville, NY, 11747, US

(73) Assignee: Xerox Corporation

(21) Appl. No.: 11/931,231

(22) Filed: Oct. 31, 2007

(51) Int. Cl. G03G 15/00

(52) U.S. Cl. 399/20

(57) ABSTRACT

In a printing system having multiple document finishing assemblies, it is sometimes necessary to purge the system of print media which, as a result of a jam or other operational malfunction, remain within the printing system in an unfinished, unprinted, or otherwise undesirable condition. These “purge sheets” can be delivered to a separate purge tray provided at each document finishing assembly. A printing system having numerous document finishing assemblies will typically have a corresponding number of purge trays which must be cleared individually by an operator, which is inefficient and burdensome. The present disclosure provides a printing system and method which, in the event of a jam, consolidates purge sheets into a minimal number of purge trays. By minimizing the number of purge trays which must be cleared by an operator, efficiency gains and productivity increases can be realized. Additionally, the disclosed printing system is responsive to subsequent or multiple jams by diverting purge sheets to the minimal number of remaining purge trays. Exemplary embodiments of the disclosed purging algorithm are presented wherein purging is coordinated by the document finishing assemblies using a decentralized daisy-chain architecture, and wherein the purging is coordinated by a controller using a centralized architecture.

### BACKGROUND

The present disclosure relates to printers and xerographic photocopying machines. In particular, disclosed herein is a printing system and method for purging undesirable document sheets by consolidating and outputting those sheets into a minimal number of purge trays.

A typical xerographic document printing or photocopying system can include at least one document processing assembly, such as a sheet feeding assembly, an imaging assembly, and a plurality of operably-coupled document finishing assemblies which function cooperatively to produce printed materials in a wide variety of formats. Ease of use and performance are desirable qualities in printing and photocopying machines. One method by which printing systems achieve higher print rates is by processing multiple sheets simultaneously in an assembly-line fashion, also known as streaming. For example, at a given moment during a print job, one sheet will be feeding from a paper supply tray, while a second sheet is being imaged, a third sheet will be passing through a fuser assembly, while yet a fourth sheet is processed in a document finishing assembly such as a sorter, collator, or binding device. The movement of the pages as they pass through the printing system is precisely timed so that a page will reach the next stage of processing just as the preceding page has completed that stage. In this manner print jobs can be completed with a minimum of delay between pages, and successive print jobs can be completed with a minimum of delay between jobs.

The increased throughput realized by such document streaming may carry a concomitant risk of decreased efficiency in the inevitable event of a malfunction such as a paper jam or misfeed, because the other sheets in the stalled assembly line must be purged together with any jammed sheets. Such purge sheets can, for example, include sheets that are improperly printed, non-imaged or damaged, properly printed yet out of collation sequence, part of an incomplete job set, or for various reasons are otherwise unacceptable.

Upon occurrence of a jam or misfeed, sensors within the printing system will detect the malfunction and cause printing to be suspended. To clear the jam two operational issues must be addressed. Firs(, the jam itself must be cleared by the operator. Second, any purge sheets remaining in the printing system situated upstream from the jam location must also be purged by the operator before printing can resume. The term “upstream” as used herein refers to the direction of the beginning of the print process, whereas term “downstream” as used herein refers to the direction of the end of the print process. As pages are processed they move in a downstream direction, that is, they move from upstream to downstream.

Purging can be accomplished by requiring an operator to manually remove the undesired sheets from the printer. However, this is a time-consuming and messy job that is not particularly enjoyable to the operator. Consequently, in order to reduce printing delays caused by the need to purge pages, techniques have been developed wherein unwanted sheets within the printer are automatically routed to a “purge tray” that is separate from the usual output tray(s). In a typical xerographic architecture, the purge tray can be a tray dedicated to the purge function, or can be any of a plurality of otherwise-unused output trays that are designated ad hoc as the purge tray(s) for a given print job.

In another typical xerographic architecture having a plurality of serially-coupled document finishing assemblies, a dedicated purge tray is provided at each document finishing assembly. When the system detects a malfunction, the sheets within each document finishing assembly are diverted to that assembly's respective dedicated purge tray. Additionally, the operator receives notification and further instructions via the system's user interface regarding where and how to clear the jam. While this is an improvement over manually removing purge sheets, this technique is still inconvenient because an operator must attend to each of multiple purge trays to clear all purge sheets generated by the malfunction. Naturally, the greater the number of document finishing assemblies configured into a system, the more inconvenient it is to clear a jam. Consider for example a system configured with five document finishing assemblies that experiences a jam in the last (most-downstream) document finishing assembly. Each of the remaining four document finishing assemblies will consequently contain some number of purge sheets, which are then purged to each respective document finishing assembly's purge tray. Thus to rectify the problem, the operator must not only clear the jam, but also go to each of four separate purge trays and clear those as well. Additionally, the operator may be required to acknowledge and/or clear each purge tray's status using the printer's user interface, further undermining productivity.

The inefficiencies in this approach are cumulative, with lost time accruing each time a jam is cleared. Inefficiencies are further compounded when taking into account those systems having numerous document finishing assemblies each having a purge tray. Many hours of productivity can be expected to be lost over the course of a printer's product life cycle. What is needed, therefore, is a more efficient method of purging sheets in systems having multiple purge trays.

### SUMMARY

It is an aspect of the present disclosure to provide an improved method for purging pages in printing and xerographic copying systems configured with multiple purge trays. In particular, disclosed is a printing system and method for reducing the number of purge trays into which purge sheets are received by consolidating purge sheets into a minimal number of purge trays. The term “jam” as used herein should be understood as referring to a condition which causes normal operation of the printing system to be interrupted, inclusive of, but not limited, to paper jams, misprints, malfunctions, misfeeds, and the like.

When a jam occurs downstream of multiple purge trays, a single purge tray that is located nearest upstream to the jam location is activated into which all purge sheets that are upstream from the jam are diverted. In one example, the single purge tray will be activated at the document finishing assembly positioned nearest upstream from the device in which the jam occurred, which typically will be the document finishing assembly positioned adjacently upstream from the jammed device. In this manner, the operator needs to clear only a single purge tray regardless of the number of document finishing assemblies configured in the system. Multiple purge trays are activated only when a secondary upstream jam occurs. In this event, those upstream purge sheets will be similarly diverted to the most downstream activated purge tray located nearest upstream from the secondary jam location, and so forth in the event additional jams occur.

Embodiments according to the present disclosure are envisioned wherein purging occurs in a direction other than the downstream direction, such as in the upstream direction, and wherein purging occurs in a direction away from either the upstream and downstream directions, such as purging sideways, perpendicular, or oblique to these directions. In an embodiment, the printing system is configured with a plurality of operatively-coupled document processing assemblies in an arrangement having at least one perpendicular branch from the longitudinal axis of the printing system. In another embodiment, the document processing assemblies are configured in a cruciform arrangement.

According to the present disclosure, a xerographic printing system and method having the capability of diverting multiple purge sheets to a minimal number of purge trays is provided. The xerographic printing system includes a scheduling module and at least one document finishing assembly. The document finishing assembly includes a jam detection processor configured to sense the occurrence of a jam or malfunction therein, and a purge control module configured to receive input from the jam detection processor, to communicate with the scheduling module, and additionally or alternatively, to manage the processing of purged sheets. In an embodiment, the system is configured to permit an operator to specify which purge trays may, or may not, be used to receive purged documents.

The purge control module is capable of communicating with the scheduling module, and, additionally or alternatively, with other purge control modules that are included within the system. In an embodiment, purging is coordinated in a generally decentralized manner wherein the purge control module can communicate with the purge control module of an adjacent document finishing assembly, using a generally daisy-chain architecture, to coordinate purging among and between the respective document finishing assemblies. In another embodiment, purging is coordinated in a generally centralized manner, wherein the purge control module of the document finishing assembly in which a jam exists communicates with the scheduling module. The scheduling module, in response, communicates with the purge control module of the document finishing assembly in which a jam exists, and with the purge control module of other document finishing assemblies included within the printing system, to coordinate purging between the respective document finishing assemblies

For example, consider a document printing system having five document finishing assemblies wherein a jam has occurred within a first document finishing assembly located downstream. The jam is sensed by the jam detection processor of the first document finishing assembly. The jam detection processor responds by notifying the purge control module of the first document finishing assembly. The purge control module responds by notifying the scheduling module of the jam, and additionally or alternatively, by causing a request to be sent to the purge control module of the second document finishing assembly, which is located adjacent to and upstream of the first document finishing assembly, to begin purging. The request to begin purging can be sent from, for example, the scheduling module and/or the purge control module.

In response to the purge request, the second document finishing assembly activates the purge tray thereof, which causes any in-process sheets contained therein to be diverted to the purge tray. Additionally, the second document finishing assembly causes a request to be sent to a third document finishing assembly, located adjacent to and upstream of the second document finishing assembly, to pass any in-process sheets contained therein to the second document finishing assembly. The second document finishing assembly then causes the incoming sheets from the third document finishing assembly to be delivered to the purge tray of the second document finishing assembly.

The third document finishing assembly causes a request to be sent to a fourth document finishing assembly adjacent to and upstream of the third document finishing assembly to pass its pages to the third document finishing assembly, which in turn, passes those pages to the second document finishing assembly where they are delivered to the purge tray. In similar fashion, the fourth document finishing assembly will cause a request to be sent to a fifth document finishing assembly adjacent to and upstream of the fourth document finishing assembly to pass its pages to the fourth document finishing assembly, which passes the pages to the third document finishing assembly, which passes them to the second document finishing assembly, which delivers the pages to the purge tray of the second document finishing assembly. In this manner, each purge sheet is delivered to a single purge tray, i.e., the purge tray of the second document finishing assembly, which enables the operator to quickly and efficiently remove the purge sheets in a single operation. It will be appreciated that the disclosure herein is readily applicable to document printing systems having any number of document finishing assemblies.

A method of method of diverting multiple purge sheets to a minimal number of purge trays in a document printing machine having a plurality of document finishing assemblies is disclosed which includes sensing the occurrence of a jam; and diverting all purge sheets that are upstream from the jam to a single downstream purge tray that is located nearest upstream to the jam location. The method can include causing a message to be sent from the document finishing assembly in which the jam is sensed to the scheduling module, or, additionally or alternatively, to a second document finishing assembly located nearest upstream therefrom; causing the second document finishing assembly to divert all purge sheets, whether originating from within or without the second document finishing assembly, to the purge tray of the second document finishing assembly; and causing a request to be sent to any additional document feeding assemblies that is located upstream from the second document feeding assembly to pass any purge pages contained respectively therein to the second document feeding assembly.

The present disclosure also provides a computer-readable medium storing a set of programmable instructions configured for being executed by at least one processor for performing a method of diverting multiple purge sheets to a minimal number of purge trays in a document printing machine having a plurality of document finishing assemblies in accordance with the present disclosure.

### BRIEF DESCRIPTION OF THE DRAWINGS

Various embodiments of the present disclosure will be described herein below with reference to the figures wherein:

FIG. 1 is a view depicting a xerographic printing system incorporating the purge algorithm in accordance with the present disclosure;

FIG. 2A illustrates a schematic diagram of a document printing system utilizing a purge algorithm in accordance with the present disclosure;

FIG. 2B shows the document printing system of FIG. 2A wherein a second jam has occurred;

FIG. 3 is a block diagram of a document printing system showing the configuration of the controller, printing and document finishing devices in accordance with the present disclosure;

FIG. 4 is a block diagram of a document finishing assembly in accordance with the present disclosure;

FIG. 5 is a block diagram of a controller in accordance with the present disclosure;

FIG. 6 is a flow diagram of a method of purging purge sheets to a minimal number of purge trays in accordance with the present disclosure;

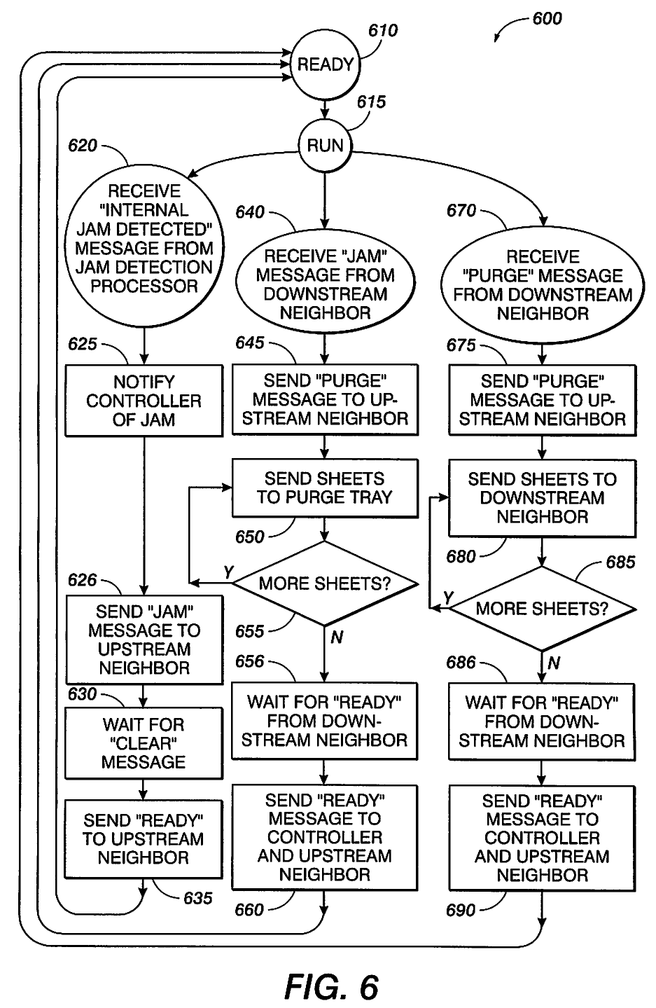

FIG. 7 is a schematic diagram of a prior art document printing system.

### DETAILED DESCRIPTION

As further described below with reference to the Figures, a printing system is disclosed that includes at least one document finishing assembly, the system having the capability of diverting purge sheets to a minimal number of purge trays.

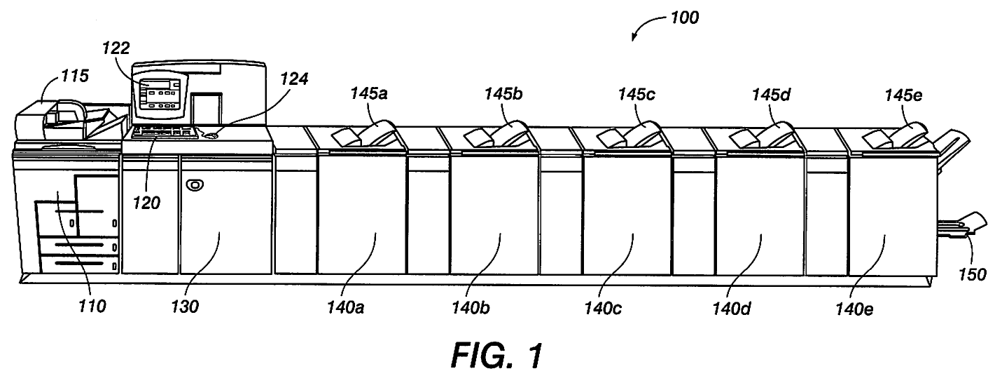

With reference to Fig. l, there is shown an exemplary xerographic printing system 100 for printing, copying documents and/or finishing documents in accordance with the present disclosure. The printing system 100 includes an imaging assembly 110 for printing documents. The imaging assembly 110 is operatively coupled to a scanner assembly 115 for scanning and copying documents. The imaging assembly 110 is further operatively coupled to at least one document finish assembly 140a et seq. having at least one purge tray 145a et seq. Where, as in the FIG. 1 example, the printing system 100 includes a plurality of document finishing assemblies, each document finishing assembly can be operably coupled to its neighboring device, i.e., an adjacent document finishing assembly 140 or imaging assembly 110. The most-downstream document finishing assembly may include an output tray 150 for receiving finished documents. Printing system 100 further includes a controller 130 which can be integral to imaging assembly 110, and user interface elements which can include a keyboard 120, a video display 122 which can further include a touchscreen, and a pointing device such as a mouse 124 and/or an alternative pointing device such as touchpad, a trackball or a graphics tablet as will be familiar to the skilled artisan.

To begin a print job, an operator chooses job options, such as the image source and finishing options, to initiate printing using user interface elements keyboard 120, video display 122 and/or pointing device 124. Additionally or alternatively, an operator can designate which purge trays are available for purging, and which trays are unavailable for purging. Additionally or alternatively, an operator can use a networked device to input job options and initiate printing using, for example, application software or a printer driver as is well-known in the art. For example, an image source can be pages scanned by scanner assembly 115 (i.e., “copy”) or previously-scanned pages saved within the printing system 100 (i.e., print-on-demand or “scan once print many”). Additionally or alternatively, a networked device such as a computer can initiate printing by transmitting a document to the printing system 100 as is well known in the art. In an embodiment, the printing system includes a raster image processor (RIP) for rendering and printing a document described in a page description language, such as PCL5™ or PostScript™.

Additionally, the operator can choose finishing options for the printing job. The options available to the user are typically dependent upon the number and type of document finishing capabilities provided by the at least one document finishing assemblies 140a et seq. configured within the system, and by the capabilities of imaging assembly 110. For example, the printed sheets can be folded, stapled, scored, hole-punched, perfect bound, tape bound, sewn, or formed into booklets.

Upon commencement of the print job, pages are printed within imaging assembly 100, passed sequentially to each document finishing assembly 140a et al. for finishing, whereafter the completed documents are delivered to output tray 150.

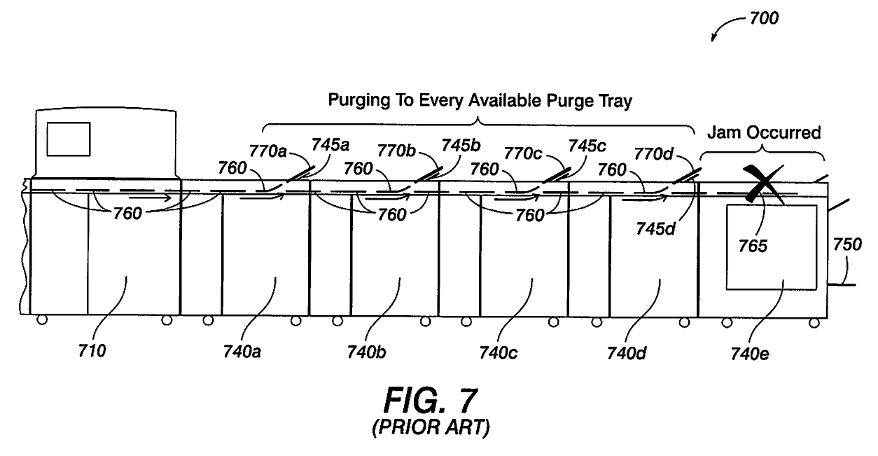

With reference now to FIG. 7, there is shown a prior-art printing system 700 having a prior-art imaging assembly 710 and at least one prior-art document finishing assembly 740a et seq. A jam 765 has occurred in prior art document finishing assembly 740e, requiring that multiple purge sheets 760, which are at various stages of completion within prior-art printing system 700, be purged. As can be seen, purge sheets within each prior-art document finishing assembly 740a et seq. are diverted, i.e., purged, to the respective purge tray 745a et seq. thereof. In this manner, multiple purge sheet stacks 770a et seq. are generated, which must be individually cleared by the operator.

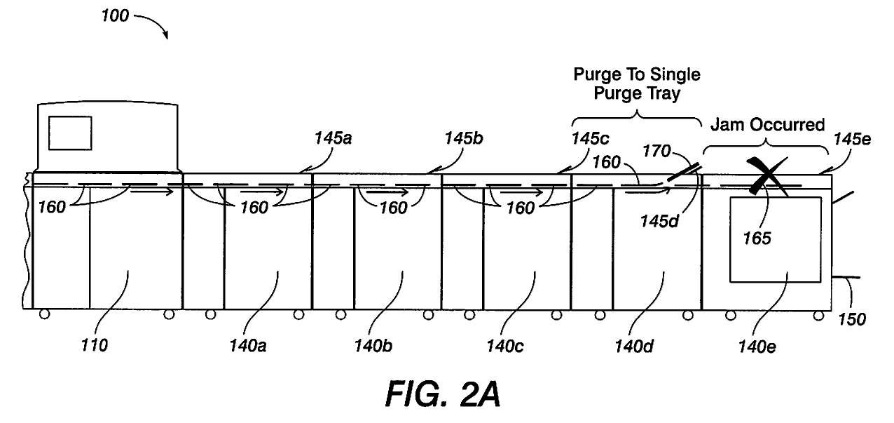

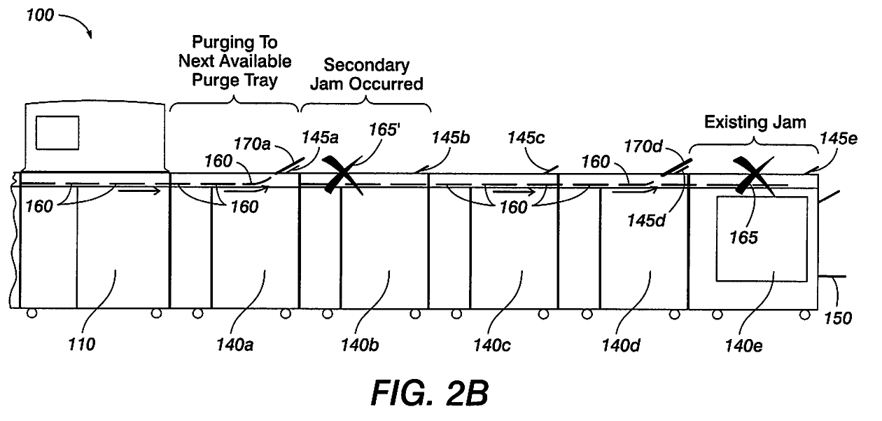

Turning to FIG. 2A, an exemplary printing system 100 according to the present disclosure is illustrated wherein a similar jam 165 has occurred within document finishing assembly 140e, requiring here that multiple purge sheets 160, which are similarly at various stages of completion within printing system 100, be purged. In accordance with the teachings herein, each purge sheet 160 is diverted to a single purge tray 145d of document finishing assembly 140d, which is the most downstream purge tray located upstream from the jam location. As will be described in further detail below, each document finishing assembly 140a et seq. can include the capability to exchange purge and jam data with its neighboring device, such as another document finishing assembly or an imaging assembly, in order to coordinate the purge.

In more detail, document finishing assembly 140e causes a jam notification to be sent to the neighboring upstream device, i.e., document finishing assembly 140d. Document finishing assembly 140d responds by purging any sheets contained therein, as well as any sheets delivered thereto by an upstream device, to purge tray 145d. Document finishing assembly 140d further responds by causing a purge notification to be sent to the next upstream document finishing assembly 140c. Document finishing assembly 140c responds by forwarding any sheets contained therein, or delivered thereto from an upstream device, to document finishing assembly 140d for purging. In similar fashion, document finishing assembly 140c causes to be sent a purge notification to document finishing assembly 140b, which responds by forwarding its sheets to document finishing assembly 140c and by causing to be sent a purge notification to document finishing assembly 140a, and so forth in a daisy-chain fashion as will be readily appreciated, until all purge pages have been forwarded from the most upstream device, which typically will be the imaging assembly 110 as illustrated in the present example, to the most downstream purge tray 145d.

Further to the current example, FIG. 2B illustrates exemplary printing system 100 where a secondary jam 165′ has subsequently occurred within document finishing assembly 140b. Upon sensing jam 165′, document finishing assembly 140b causes a jam notification to be sent to document finishing assembly 140a. Document finishing assembly 140a, upon receipt of the jam notification, begins purging to purge tray 145a. Printer assembly 110, which previously received a purge notification sent by document finishing assembly 140a and thus forwarding its purge pages downstream, is unaffected by the subsequent jam 165′. Similarly, the secondary jam 165′ has no impact upon document finishing assemblies 140c-e, which continue to purge to purge tray 145d. In this manner, it will be readily appreciated that a printing system according to the present disclosure can respond to any number of jams by routing purge pages to the minimum possible number of purge trays.

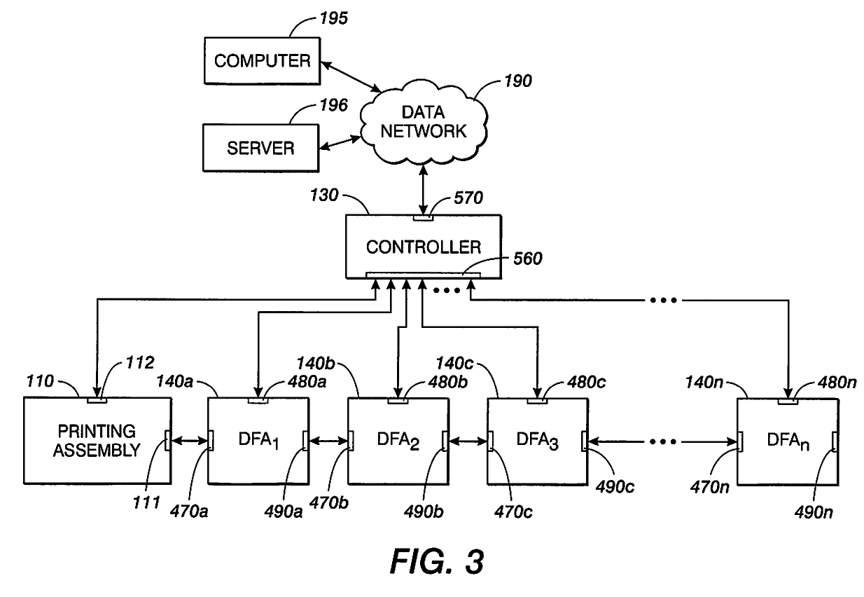

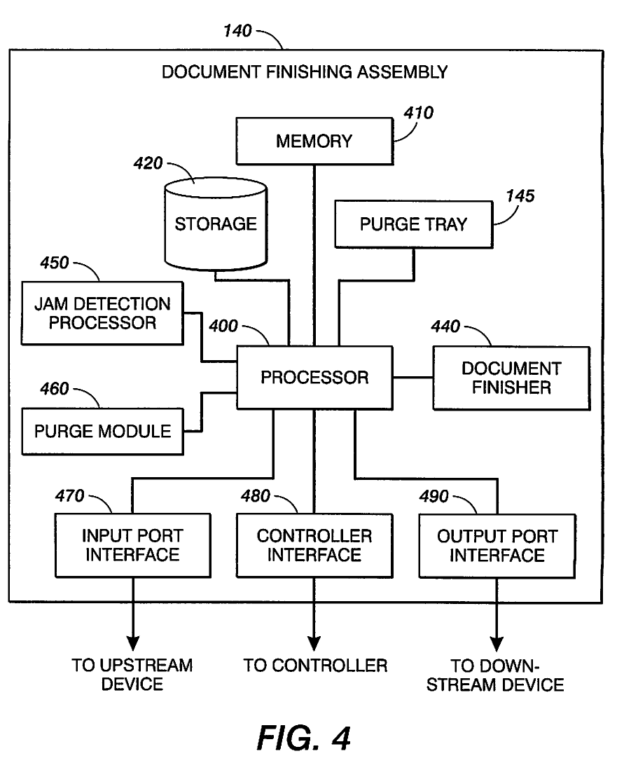

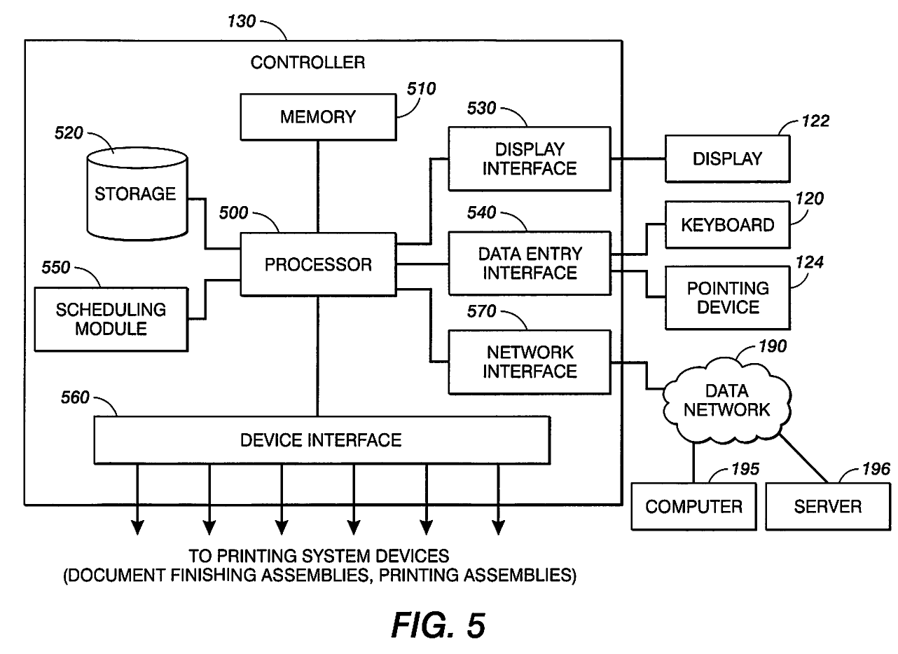

An exemplary embodiment according to the present disclosure are shown in FIGS. 3-5. Controller 130 includes a device interface 560 for communicating with document finishing assembly 140a et seq. and imaging assembly 110. Document finishing assembly 140a et seq. includes a corresponding controller interface 480a et seq. which is operatively coupled to controller 130 by device interface 560. Imaging assembly 110 includes a corresponding controller interface 112 which is operatively coupled to controller 130 by device interface 560. Document finishing assembly 140a et seq. further include input port interface 470a et seq. and output port interface 490 et seq. for communicating with upstream and downstream devices, respectively. Imaging assembly 110 further includes an output port interface 111 for communicating with a downstream device such as a document finishing assembly 140a et seq. Controller 130 further includes network interface 570 for communicating with networked devices such as a computer 195 or a server 196 via data network 190. It is to be understood that the interfaces presented herein can be embodied in hardware, software, or a combination thereof, and can include electrical connections, optical connections or logical connections in a point-to-point, network, bus, daisy chain configuration, or any suitable configuration now or in the future known in the art.

Document finishing assembly 140 further includes a purge module 460 and at least one processor 400. Purge module 460 includes a software program having a set of programmable instructions configured for execution by the at least one processor 400 of the document finishing assembly 140 for purging sheets in a print job. The at least one processor 400 is operatively coupled to a jam detector processor 450; a document finisher 440; and a purge tray 145. Document finisher 440 can include, for example, a stapler, hole puncher, folder, booklet maker or bookbinder as is well-known in the art. Additionally, document finishing assembly 140 includes memory 410, which can be RAM, ROM, or a combination thereof, and at least one storage device 420 such as a hard disk or flash memory.

Controller 130 further includes a scheduling module 550 and at least one processor 500. Scheduling module 550 includes a software program having a set of programmable instructions configured for execution by the at least one processor 500 of the controller 130 for coordinating the various devices of the document printing system, such as the imaging assembly 110, the scanner assembly 115, and the at least one document finishing assembly 140 during a print job. Additionally, controller includes memory 510, which can be RAM, ROM, or a combination thereof, at least one storage device 520 such as a hard disk or flash memory, a display interface 530 for coupling to display 122, and data entry interface 570 for coupling to data entry devices such as keyboard 120 and/or pointing device 124.

During normal operation, i.e., no jams are detected within printing system 100, purge module 460 remains in a quiescent “ready” state 610 whereby purge module 460 awaits receipt of any of an internal jam detected message from jam detection processor 450; receipt of a jam message from a document finishing assembly 140 located downstream therefrom; or receipt of a purge message from a document finishing assembly 140 located downstream therefrom. Additionally or alternatively, purge module 460 awaits receipt of a jam message or purge message from controller 130. In an embodiment, purge module 460 awaits receipt of a message using any of a polling loop, interrupt-driven execution, message queuing, object events or other suitable messaging means as will be familiar to the skilled artisan.

Upon receipt of an internal jam detected message in the step 620, purge module 460 causes controller 130 to be notified of the jam in the step 625, and in the step 626 purge module 460 causes to be sent a jam message to a device, such as a document finishing assembly 140 or an imaging assembly 110, that is located upstream therefrom. Purge module 460 then waits for a “clear” message in the step 630 during which time the operator is able to clear the jam condition. In response to the jam being cleared, a “clear” message is caused to be received by the purge module 460. In an embodiment, a “clear” message is caused to be sent by the jam detection processor 450. In an alternative embodiment, a “clear” message is caused to be sent by controller 130 in response to receiving a user input that the jam has been cleared. Upon receipt of a “clear” message, purge module 460 causes to be sent in the step 635 a ready message to the adjacent upstream device, and returns to the ready state 610.

Upon receipt of a jam message in the step 640, purge module 460 causes to be sent in the step 645 a purge message to a device, such as a document finishing assembly 140 or an imaging assembly 110, that is located immediately upstream thereto. In the step 650, purge module 460 causes purge sheet to be sent to purge tray 145. In an embodiment, a message can be sent to document finisher 440 and/or to purge tray 145 to effectuate purging of sheets to purge tray 145. Purge sheets can include those sheets initially contained within document finishing assembly 140 upon receipt of the jam message, and can include those sheets received by document finishing assembly 140 from upstream devices. Purging of sheets continues until in the step 655 it is determined all sheets have been purged, whereupon in the step 656 purge module 460 waits for receipt of a ready message from the downstream device. Upon receipt of the a ready message, purge module 460 in the step 660 causes to be sent a ready message to controller 130 and to the adjacent upstream device, i.e., an upstream document finishing assembly 140 or an imaging assembly 110, and returns to the ready state 610.

Upon receipt of a purge message in the step 670, purge module 460 causes to be sent in the step 675 a purge message to an adjacent upstream device, such as a document finishing assembly 140 or an imaging assembly 110. In the step 680, purge module 460 causes purge sheets to be sent to purge tray 145 as previously described above. Purging of sheets continues until in the step 685 it is determined all sheets have been purged, whereupon in the step 686 purge module 460 waits for receipt of a ready message from the adjacent downstream device. Upon receipt of the a ready message, purge module 460 in the step 690 causes to be sent a ready message to controller 130 and to the adjacent upstream device, i.e., an upstream document finishing assembly 140 or an imaging assembly 110, and returns to the ready state 610. It is contemplated that the steps of the method in accordance with the present disclosure can be performed in a different ordering than the ordering provided herein. It is further contemplated that purging can occur in a direction other than the downstream direction, such as the upstream, perpendicular or oblique direction.

Also disclosed is a computer-readable medium storing a set of programmable instructions configured for being executed by at least one processor of a document printing system for performing a method of purging sheets in accordance with the present disclosure.

It will be appreciated that variations of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. The claims can encompass embodiments in hardware, software, or a combination thereof.

What is claimed is:

1. In a printing system having a plurality of operably-coupled document processing assemblies, wherein at least two of said document processing assemblies each include at least one purge tray, a method for purging sheets comprising:
detecting the occurrence of a jam within a document processing assembly;
activating at least one purge tray of the document processing assembly located nearest to the document processing assembly in which the jam is detected; and
causing the purge sheets to be delivered to the at least one activated purge tray of the document processing assembly located nearest to the document processing assembly in which the jam is detected.

2. The method in accordance with claim 1, wherein the activated purge tray is located nearest upstream from the document processing assembly in which the jam is detected.

3. The method in accordance with claim 1, further comprising:
causing to be sent a jam message to the document processing assembly located nearest to the document processing assembly in which the jam is detected.

4. The method in accordance with claim 3, further comprising:
in response to receipt of a jam message by a document processing assembly, causing to be sent a purge message to a document processing assembly located nearest to the document processing assembly in receipt of the jam message.

5. The method in accordance with claim 4, further comprising:
in response to receipt of a purge message by a document processing assembly, causing to be sent a purge message to a document processing assembly located nearest to the document processing assembly in receipt of the purge message.

6. The method in accordance with claim 1, further comprising:
in response to receipt of a clear message by the document processing assembly in which the jam was detected, causing to be sent a ready message to the document processing assembly located nearest to the document processing assembly in which the jam was detected.

7. The method in accordance with claim 6, further comprising:
in response to receipt of a ready message, causing to be sent a ready message to the document processing assembly located nearest to the document processing assembly in receipt of the ready message.

8. The method in accordance with claim 6, wherein the clear message is received in response to detecting the clearing of the jam within the document processing assembly in which the jam was detected.

9. The method in accordance with claim 6, wherein the clear message is received in response to a user input.

10. The method in accordance with claim 1, wherein the printing system is a xerographic printing system.

11. The method in accordance with claim 1, wherein the printing system is a photocopying system.

12. The method in accordance with claim 1, further comprising:
in response to a user input, causing to be prevented the activation of at least one purge tray.

13. A printing system, comprising:
a plurality of operably-coupled document processing assemblies, wherein at least two of said document processing assemblies further comprise:
at least one purge tray,
at least one processor;
a purge module for causing multiple purge sheets to be diverted to a minimal number of purge trays; and
a jam sensing processor to sense the occurrence of a jam within the document finishing assembly thereof.

14. The system in accordance with claim 13, wherein the document processing assemblies are selected from the group consisting of an imaging assembly, a sheet feeding assembly, and a document finishing assembly.

15. The system in accordance with claim 14, wherein the at least one document finishing assembly is configured to perform at least one of folding, stapling, scoring, hole punching, perfect binding, tape binding, sewing, or booklet-making.

16. The system in accordance with claim 13, wherein the purge module includes a program having a set of programmable instructions configured for execution by the at least one processor for causing multiple purge sheets to be diverted to a minimal number of purge trays.

17. The system in accordance with claim 13, wherein the document processing assembly includes at least one interface for communicating with an adjacent document processing assembly.

18. The system in accordance with claim 13, further comprising at least one controller, the at least one controller further comprising:
at least one processor;
at least one user interface element selected from the group consisting of a display, a keyboard, a pointing device, and a touchscreen; and
a device interface for communicating with at least one document processing assembly.

19. The system in accordance with claim 18, wherein the document processing assembly includes at least one controller interface for communicating with the controller.

20. The system in accordance with claim 18, the at least one controller further comprising a scheduling module having a set of programmable instructions configured for execution by the at least one processor for causing multiple purge sheets to be diverted to a minimal number of purge trays.

21. The system in accordance with claim 13, further configured to accept a user input and in response thereto causing to be prevented the diversion of one or more purge sheets to at least one purge tray.

22. The system in accordance with claim 13, wherein the printing system is a xerographic printing system.

23. A computer-readable medium storing a set of programmable instructions configured for being executed by at least one processor for performing a method for delivering multiple purge sheets to a minimal number of purge trays comprising:
detecting the occurrence of a jam within a document processing assembly;
activating at least one purge tray of the document processing assembly located nearest to the document processing assembly in which the jam is detected; and
causing the purge sheets be delivered to the at least one activated purge tray of the document processing assembly located nearest to the document processing assembly in which the jam is detected.
